(19) United States
(12) Patent Application Publication
(10) Pub. No.: US 2026/0295959 A1
(43) Pub. Date: Oct. 1, 2026

(54) A MOLD FOR MOLDING A CONTAINER INTO A TIRE

(71) Applicant: COMPAGNIE GENERALE DES ETABLISSEMENTS MICHELIN, Clermont-Ferrand (FR)

(72) Inventors: Daniel REY, Belton, SC (US); Johnny Irvin SCRUGGS, Boiling Springs, NC (US)

(21) Appl. No.: 19/479,571

(22) PCT Filed: May 13, 2024
(86) PCT No.: PCT/US2024/029104

§ 371 Date: Oct. 28, 2025

Related U.S. Application Data
(60) Provisional application No. 63/502,463, filed on May 16, 2023.

(51) Int. Cl. B29D 30/00

(52) U.S. Cl. CPC B29D 30/0061; B29D 2030/0072; B29K 2905/02

(57) ABSTRACT

A mold for molding a tire that has a container. The mold has a bladder with a flexible portion that has a flexible portion inner surface and a flexible portion outer surface. A plurality of mold sectors are distributed around the bladder. A mounting portion is included that is carried by the flexible portion at a location of the flexible portion that lacks a through aperture from the flexible portion inner surface to the flexible portion outer surface. Also, a puck is attached to the mounting portion with a cavity configured for molding the container onto an inner surface of the tire.

### FIELD OF THE INVENTION

The present invention relates generally to a mold for molding a tire that has a container in the tire that can be used to hold items such as a sensor. More particularly, the present application involves a mold that utilizes a bladder with a flexible portion that lacks a through aperture at a mounting portion that is used to hold a puck that in turn molds the container onto the inner surface of the tire.

### BACKGROUND

It is known to place sensors into the tires of vehicles in order to measure such things as tire inflation pressure, tire temperature, tire acceleration, tire velocity, and other parameters. Such electronic sensors typically require a container to be fixed inside of the tire into which the sensor is inserted and retained. The container can have a cavity into which the electronic sensor is placed, and one known sensor container includes a lip that surrounds a portion of the top of an electronic sensor and holds it in place in the cavity. The lip is made of a flexible material and is rolled back to allow the sensor to be pushed past it and into the cavity. The flexible lip can then be flipped back into its original position, and in so doing engage the sensor and function to retain it in the cavity. The holding of the electronic sensor within the tire should be strong enough to keep the electronic sensor in place upon being subjected to high acceleration, forces, and temperatures during operation of the vehicle.

The container can be a piece that is separately formed and then subsequently attached to the tire once the tire has been molded. This attachment can be made by using green rubber or adhesive to bond the rubber container to the inner layer of the tire. However, the subsequent attachment of a separate piece adds weight and additional processing steps to the overall production of the tire. Another way of providing a container to the interior of the tire is by molding it into the tire during the production process. This process results in the formation of a flap on the inner surface of the tire, and requires the positioning of additional separating components and the careful removal of such components once the molding is completed. The resulting flap/container is flat and has an aperture immediately adjacent the inner surface of the tire. Although capable of holding a flat sensor, such a manufacturing process cannot produce a flap/container capable of holding a non-flat shaped electronic sensor and limits the location and shape of the container.

A further method of molding a container onto the inner surface of the tire is disclosed in patent application publication WO 2021/126199 entitled “Method of Molding a Container into a Tire” which is owned by the present Applicant and is incorporated by reference herein in its entirety for all purposes. This method involves the placement of a puck onto a flexible bladder of a mold which is used to mold the container onto the inner surface of the tire when at the same time the rest of the tire is being molded by the mold. Although capable of molding the container onto the inner surface, the disclosed method presents certain manufacturing challenges. For example, in one embodiment the puck is located within a concave cavity of the flexible bladder. The construction of a flexible bladder with such a cavity that can expand and contract during production is not industrially practical. In a different embodiment, the puck is attached to the outside of the flexible bladder by the use of a mechanical fastener that extends through the sidewall of the flexible bladder. Although capable of holding the puck, this arrangement introduces a hole into the flexible bladder through which fluid may leak, and is thus not a practical way of constructing the mold.

A yet additional way of forming a container within a tire involves providing a solid core drum that has a cavity into which rubber flows during molding of the tire. A container formed by a solid core drum process may be capable of holding electronic sensors that are not of a flat shape. However, the use of a solid core in the production of tires with containers may require variously sized solid cores to be produced when manufacturing tires of different types and sizes. Although different techniques are known for producing tires that have containers for holding sensors, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a tire that has a container.

FIG. 2 is a side cross-sectional view of a portion of the tire that includes the container.

FIG. 3 is a side view of a mold that has a bladder with a puck.

FIG. 4 is a side cross-sectional view of the mold of FIG. 3 with the bladder unactuated.

FIG. 5 is a side cross-sectional view of the mold of FIG. 4 with the bladder partially actuated.

FIG. 6 is a side cross-sectional view of the mold of FIG. 5 with the bladder fully actuated.

FIG. 7 is a side cross-sectional view of the mold of FIG. 6 with the bladder deflated and disengaged from the interior of the tire and the newly formed container.

FIG. 8 is a side cross-sectional view of a mold with a bladder having a puck in accordance with another exemplary embodiment.

FIG. 9 is a perspective view of an inner core mold for use in forming the bladder of the embodiment in FIG. 8.

FIG. 10 is a side cross-sectional view of the inner core mold of FIG. 9 with the bladder formed thereon.

FIG. 11 is a side view of the bladder of FIG. 10 after being removed from the form and turned inside out and with a slit cut therein.

FIG. 12 is a front view of a form for use in forming the bladder of FIG. 4.

FIG. 13 is a side cross-sectional view of the form of FIG. 12 with the bladder formed thereon.

FIG. 14 is a perspective view of a puck in accordance with another exemplary embodiment.

FIG. 15 is a side cross-sectional view of a mold with a bladder having the puck of FIG. 14 in accordance with another exemplary embodiment.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

A mold 14 for molding a container 12 into a tire 10 is provided that includes a bladder 16 that has a puck 20. The puck 20 is carried by a flexible portion 18 of the bladder 16 and is a separate piece that is attached to the flexible portion 18. In this regard, the flexible portion 18 carries a mounting portion 82 at a location of the flexible portion 18 that does not have a through aperture. The puck 20 is attached to this mounting portion 82 to result in an arrangement that lacks an aperture through the flexible portion 18 at the area of the connection with the puck 20. During the molding process, the flexible portion 18 is inflated and pressed against the inner surface 24 of the green tire 10. The puck 20 includes a cavity 22 into which rubber of the green tire 10 flows during the molding process. Once the tire 10 is cured to an extent, the mold 14 is opened and the bladder 16 deflated to cause the puck 20 to be pulled off of the container 12 which is now formed on the inner surface 24 of the tire 10. The puck 20 can be configured in a variety of manners in accordance with different exemplary embodiments of the process.

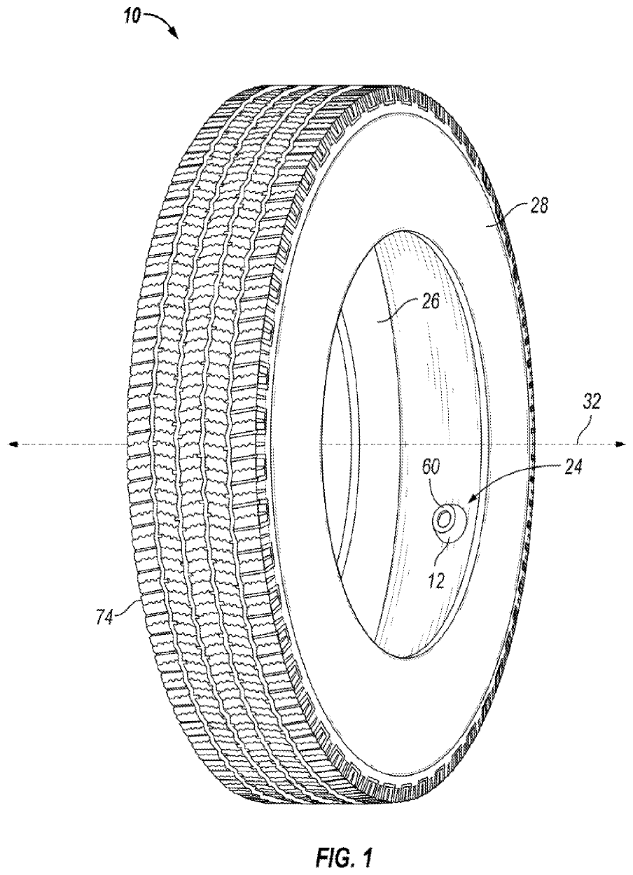

FIG. 1 shows a tire 10 with an axis 32 that extends in the axial direction and tread 74 that extends completely 360 degrees around the axis 32 in the circumferential direction of the tire 10. The tire 10 has a pair of sidewalls 26, 28 that are included in a carcass portion of the tire 10 onto which the tread 74 is located. An inner surface 24 of the tire 10 is located opposite the tread 74 and extends between the inner sides of the first sidewall 26 and the second sidewall 28. The container 12 is formed on the inner surface 24 and extends from the inner surface 24 towards the axis 32 in a radial direction of the tire 10 such that the container 24 is located closer to the central axis 32 than the inner surface 24.

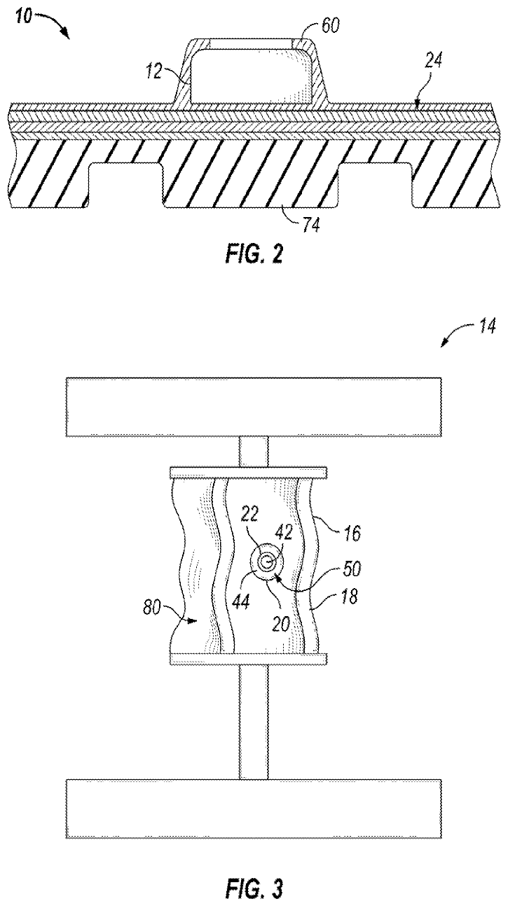

A cross-section of the container 12 and a portion of the tire 10 is illustrated with reference to FIG. 2. The tread 74 resides on top of a carcass of the tire 10 that can include a number of layers that may have belts therein. The inner surface 24 of the tire 10 includes the container 12. The container 12 may be made out of the same material as that which makes up the inner surface 24, or could be made out of a different material than the inner surface 24. The container 12 may be thought of as being part of the inner surface 24 or may be thought of as being attached to the inner surface 24. The container 12 is integrally formed with the inner surface 24 because the container 12 is formed at the same time the inner surface 24 of the tire 10 is cured in the mold 14 and is not attached subsequent to molding of the tire 10 or inner surface 24. It is to be understood that integral formation of the container 12 includes arrangements where the container 12 is made of a different material than the tire 10 or the inner surface 24 but is attached thereto via the molding process of the tire 10.

The container 12 has an internal void into which a sensor, such as an electronic sensor, could be located. A sidewall of the container 12 extends upwards from the inner surface 24 in the radial direction of the tire 10, over 9 millimeters in some arrangements, and can be of any shape such as circular, oval, or rectangular. In other embodiments, the sidewall of the container 12 extends from 8 to 10 millimeters, from 8 to 13 millimeters, from 12 to 20 millimeters, or greater than 12 millimeters in the radial direction from the inner surface 24. The container 12 has a lip 60 that extends from the sidewall at the portion of the sidewall that is closest to the axis 32 to cover a portion of the cavity of the container 12. An opening into the interior of the container 12 is defined by the lip 60 to allow the sensor to be placed therein. As previously described, the lip 60 could be peeled up to allow insertion of the sensor and then subsequently pushed back into the FIG. 2 position to securely hold the sensor into the container 12. The container 12 may be configured so that only a single, and no more than a single, opening into the interior of the container 12 exists and faces only in the radial direction of the tire 10, and does not face in the axial direction.

The mold 14 for forming the tire 10 includes a bladder 16 that is located within the interior portion of the mold 14 so as to be generally located inside of a mold cavity formed by mold sectors 62, 64, an upper mold half 66, and a lower mold half 68. The various mold 14 pieces 62, 64, 66, 68 may move towards or away from one another in order to open up the mold 14 to allow the mold 14 to close onto the tire 10 and apply pressure to the tire 10. Heating elements can be located within the various segments 62, 64, 66, 68 to transfer heat into the tire 10 that is within the mold 14. Although described as all being movable, it may be the case that some of the segments 62, 64, 66, 68 are not movable while others are in fact movable to open and close the mold 14. The segments 62, 64, 66, 68 may be movable in that they move relative to the ground onto which the mold 14 rests.

FIG. 3 shows a bladder 16 in accordance with one embodiment. The bladder 16 has a flexible portion 18 that can be made of rubber and has an interior in fluid communication with a supply source or pressure source via a conduit (not shown). The bladder 16 is in the deflated state in FIG. 3 in which fluid 72 is not present within the interior of the flexible portion 18 sufficient to expand the flexible portion 18. The flexible portion 18 has flexible portion outer surface 80 that carries a mounting portion 82 onto which the puck 20 is located. The puck 20 includes a cavity 22 that is visible in FIG. 3 and thus accessible from the exterior of the bladder 16. The puck 20 may be a different material than the flexible portion 18, and can be made of a material that is more rigid than the flexible portion 18.

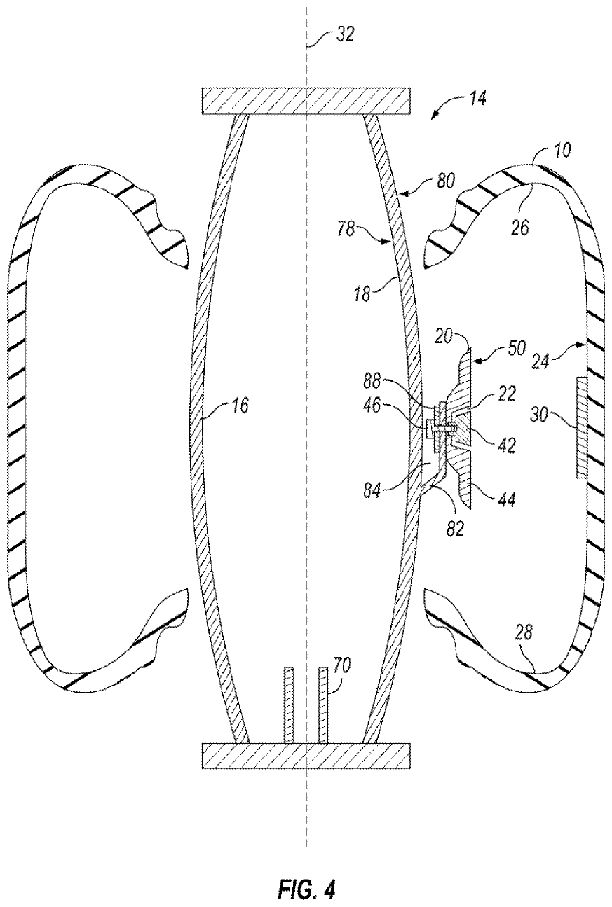

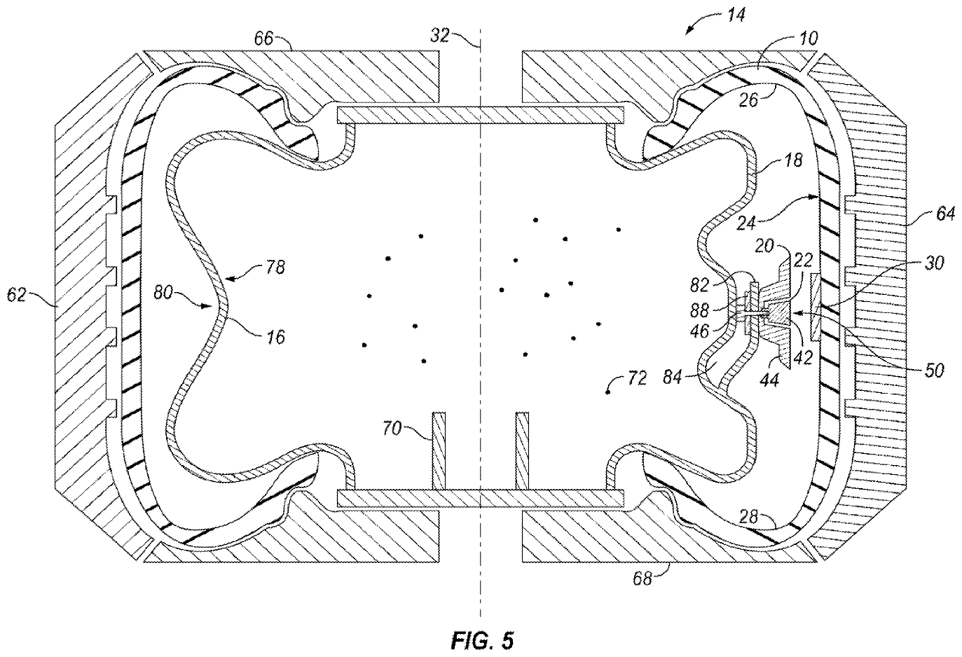

FIG. 4 shows a step in the process of forming a tire 10 using the bladder 16 of FIG. 3. A green tire 10, which is an uncured tire 10, is located around the bladder 16 so that the bladder 16 is located in the interior of the tire 10. The puck 20 may be made of aluminum or steel. The puck 20 is made of a first piece 42 and a second piece 44 that are connected together by a mechanical fastener 46. The space between the first and second pieces 42, 44 defines the cavity 22 into which rubber flows for use in forming the container 12. The mechanical fastener 46 in addition to connecting the first and second pieces 42, 44 together also effects attachment of the first and second pieces 42, 44 to the flexible portion 18. A mounting portion 82 extends from the flexible portion outer surface 80 and is integrally formed with the flexible portion 18. The mounting portion 82 can be described as a tab, and may be made of the same material as the flexible portion 18. The mounting portion 82 is not attached to the flexible portion 18 through the use of mechanical fasteners that extend through the flexible portion 18. Instead, the attachment is either by way of integral formation to the flexible portion 18, or in some cases via adhesive to attach the mounting portion 82 to the flexible portion 18. In no cases does the attachment of the mounting portion 82 to the flexible portion 18 involve creating an aperture through the flexible portion 18 from the flexible portion inner surface 78 to the flexible portion outer surface 80. In this regard, at the area of the flexible portion 18 proximate to the mounting portion 82, a through aperture does not exist. In various embodiments, the flexible portion 18 lacks a through aperture at any location and is completely solid around its entire perimeter, except for a port or ports that may be present at the top or bottom of the mold 14. Inflation port 70 is shown at the bottom of the mold for introducing fluid 72 into the interior of the bladder 16 to cause inflation of the flexible portion 18. The sidewall of the bladder 16 that is made of the flexible portion 18 may be flexible, but completely solid while the top and bottom of the bladder 16 are made of rigid materials and may have one or more ports that extend therethrough for fluid 72 introduction and evacuation.

The mounting portion 82 when configured as a tab defines a space 84 between it and the flexible portion outer surface 80. Part of the mechanical fastener 46 can be located within the space 84. When the mechanical fastener 46 is a bolt, the head of the bolt is within the space 84. A plate 88 engages the mounting portion 82 and can be made of a rigid material such as steel or aluminum. The mechanical fastener 46 extends through the plate 88 and the mounting portion 82, and engages both of the pieces 42, 44. When tightened, the mechanical fastener 46 pushes the plate 88 against the mounting portion 82 can pulls the first and second pieces 42, 44 against one another and in turn against the mounting portion 82. The plate 88 provides a rigid point of engagement of the mechanical fastener 46 and distributes this tightening force to a larger area of the mounting portion 82. The disclosed arrangement causes the puck 20 to be securely held onto the mounting portion 82, and then as a consequence in turn securely held onto the flexible portion 18. As can be seen, the mounting portion 82 is not a part of the bladder 16 that is inflated, so placement of a through aperture through the mounting portion 82 does not cause any fluid 72 loss. As such, although the mounting portion 82 may have one or more apertures through it, there are no apertures at the mounting portion 82 that go from the flexible portion inner surface 78 to the flexible portion outer surface 80 and such no apertures that would cause fluid loss.

The container 12 is molded by the puck 20, and material must be available to flow into the puck 20 for this purpose. A patch 30 is placed onto the inner surface 24 of the green tire 10. The patch 30 can be a section of uncured cushion gum, or any type of desired uncured rubber and can be applied onto the inner surface 24 in any manner. The patch 30 does not extend 360 degrees around the axis 32 on the inner surface 24, but is limited in location to just the area that the container 12 will be formed. In this regard, the patch 30 does not extend from one sidewall 26 to the other sidewall 28, but is spaced from both of the sidewalls 26, 28 in the axial direction. The patch 30 can be material provided into the green tire 10 for the express purpose of forming the container 12, and not material introduced into the tire 10 for purposes of forming the inner layer of the tire 10, which is generally a layer that inhibits air transfer through the tire 10. However, other embodiments are possible where the patch 30 is an entire inner layer of the tire 10 and thus makes up the inner layer of the tire 10 that is more air impermeable than the rest of the tire 10. This layer may extend all the way from one sidewall 26 to the other sidewall 28. In yet other embodiments, the patch 30 is spaced from the sidewalls 26, 28 in the axial direction, but extends completely 360 degrees about the inner surface 24 about the axis 32. In some instances, the patch 30 is cushion gum that is added to the inner surface 24 which is also made of cushion gum so that the layer making up the inner surface 24 is increased in thickness by 1 or 1.5 times and this extra cushion gum is profiled onto the inner surface 24 so that it does not extend across the entire width of the inner surface 24 from one sidewall 26 to the other sidewall 28.

FIG. 5 shows the tire 10 of FIG. 4 placed inside of the mold 14 that includes various mold sectors 62, 64 positioned around the tire 10 360 degrees about the axis 32. Although two mold sectors 62, 64 are visible in FIG. 5, additional sectors are present. The sectors 62, 64 include patterns that can be molded into the exterior surface of the tire 10 for use in forming the tread 74. An upper mold half 66 can be moved at the top of the mold 14 to cover the sidewall 26 and may include a pattern that can impart architecture to the exterior of the sidewall 26. In a similar fashion, the mold 14 includes a lower mold half 68 opposite the upper mold half 66 in the axial direction. The lower mold half 68 may impart a design onto the exterior surface of the sidewall 28. With the mold 14 closed so the mold sectors 62, 64 and the mold halves 66, 68 surround the tire 10, fluid 72 can be introduced into the interior of the bladder 16 via an inflation port 70 to cause the bladder 16 to be pressurized. The flexible portion 18 is shown as being expanded from the deflated position in FIG. 4, but is not completely inflated such that the flexible portion 18 does not fully contact the inner surface 24. The puck 20 is aligned with the patch 30 such that inflation of the bladder 16 causes it to approach the patch 30.

The fluid 72 located within the bladder 16 can be any type of fluid such as air, water, steam, or nitrogen. Further, the fluid 72 may be any combination of fluids such as being both water and steam, or some combination of air and nitrogen. The conduit leading to the inflation port 70 and bladder 16 may be located in the same position with respect to the ground, or may move as well relative to the ground when the mold 14 is moved between the closed and open positions. Although shown as having but a single aperture that functions as both an inlet and exit for the fluid 72, the bladder 16 can have two or more openings in other embodiments into which fluid 72 may flow. These openings may be dedicated inlets and outlets, or all of the various openings may function as both inlets and outlets.

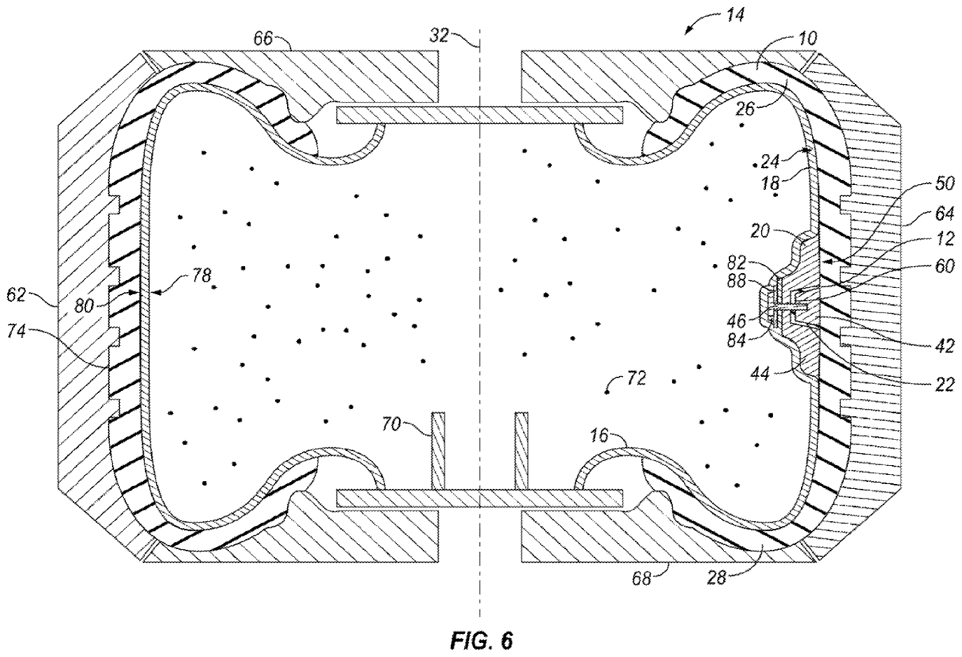

FIG. 6 shows the bladder 16 fully inflated via the fluid 72 so that the flexible portion 18 fully engages the inner surface 24. The bladder 16 is pressurized to the point that it presses against the inner walls of the tire 10 that is in the mold 14. The bladder 16 thus forms an interior surface against which the tire 10 is pressed via application of pressure to the exterior of the tire 10 from the segments 62, 64, 66, 68. The bladder 16 may also apply its own pressure to the interior of the tire 10 to cause the tire 10 to be compressed between all of the elements 62, 64, 66, 68. The mold 14 may be heated to also cause curing of the tire 10 and the material in the cavity 22. Heating elements within the various mold elements 62, 64, 66, 68 or other portions of the mold 14 may be used to transfer heat into the tire 10 and container 12. Pressure applied by the mold components 62, 64, 66, 68 and by the bladder 16 causes pressure to be applied to the green tire 10 to impart the tread 74 and other architectural features into the tire 10 and to cause, with heat and time, curing of the tire 10. Additionally, the puck 20 is pressed against the patch 30 and the material of the patch 30 flows into the cavity 22 that is defined in the puck 20. The cavity 22 is shaped and sized so that this material will be molded into a container 12 of an accordingly desired shape and size. All of the material of the patch 30 can flow into the cavity 22, or some of the patch 30 material can flow into the cavity 22 while other material of the patch 30 remains on the inner surface 24 and does not flow into the cavity 22 to form the container 12. In some instances, at least 60 bar of pressure can be applied against the tire 10 so that material flows into the cavity 22. However, in other embodiments less than 60 bar of pressure is applied to the tire 10 to cause material to flow into the cavity 22 to form the container 12.

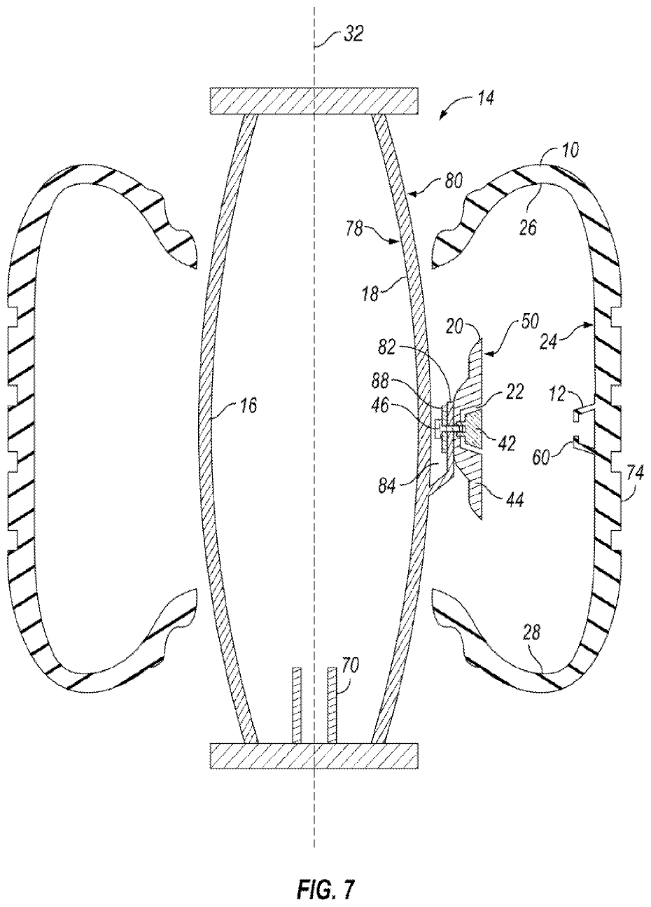

After a sufficient amount of time, the pressure in the bladder 16 can be released by venting or otherwise removing some or all of the fluid 72 from the interior of the bladder 16 so that the flexible portion 18 disengages the inner surface 24 and removes pressure on the tire 10. FIG. 7 shows the bladder 16 deflated such that the flexible portion 18 does not engage the tire 10, and so that upon retraction the puck 20 is pulled from engagement with the tire 10 leaving the molded container 12 onto the inner surface 24. The lip 60 may resist demolding since it is formed within a corresponding lip within the cavity 22. However, the lip 60 is flexible enough that it will be pulled from within the cavity 22 upon deflation of the bladder 16. The container 12 will remain on the inner surface 24 and can thus be integrally molded with the rest of the tire 10 during the molding of the tire 10. The tire 10, with the included container 12, may be completely cured upon the deflation of the bladder 16, or curing of these warm items 10, 12 may continue for some time after the bladder 16 is deflated and the other mold components 62, 64, 66, 68 opened and the tire 10 and attached container 12 removed from the mold 14. The puck 20 remains attached to the mounting portion 82 after deflation, and this arrangement can be reused for curing a subsequent tire 10 and container 12.

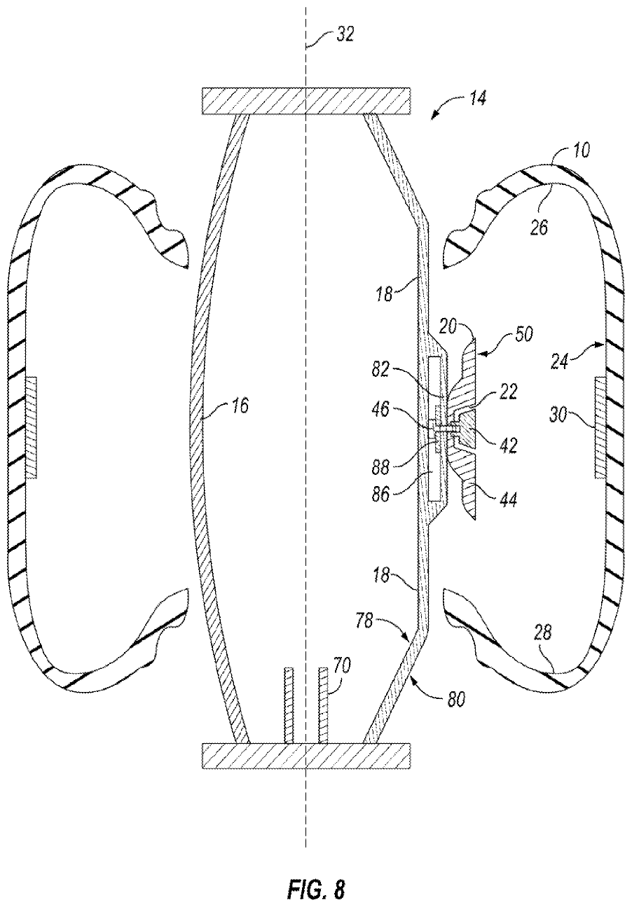

A variation of the mold 14 is shown with reference to FIG. 8. The process is similar to that previously described and a complete repeat of the same information is not needed. The mold 14 differs in that the mounting portion 82 and a second of the flexible portion 18 are different from those previously described. The puck 20 is the same as previously described and is again held onto the mounting portion 82 by way of a mechanical fastener 46 and plate 88. The cavity 22 is again formed by the space between the first and second pieces 42, 44 and both of these pieces 42, 44 engage the patch 30 during the molding process. Although shown as being made of two pieces 42, 44, additional number of pieces can be included in the puck 20 in accordance with other exemplary embodiments. The patch 30 extends 360 degrees about the axis 32 on the inner surface 24.

The flexible portion 18 has a section that is thicker in that the distance between the flexible portion inner surface 78 and the flexible portion outer surface 80 is greater than other parts of the flexible portion 18. The area of the mounting portion 82 is thicker than other areas of the flexible portion 18. This area of the mounting portion 82 may be described as a projection in that it projects from the flexible portion 18. A through slit 86 is cut into this thicker portion, projection, but the through slit 86 does not extend into or through the flexible portion inner surface 78 so that no through aperture is created into the interior of the bladder 16. Instead, the through slit 86 extends in a direction perpendicular to the direction of the axis 32. The through slit 86 is open on two ends and closed on the remaining portions. To attach the puck 20, the plate 88 is placed into the through slit 86 along with a portion of the mechanical fastener 46. The mechanical fastener 46 extends through the piece of the mounting portion 82 radially outboard of the through slit 86 and engages the first and second pieces 42, 44 drawing the puck 20 up against and securely onto the mounting portion 82. The plate 88 is again present to spread the force of attachment of the mechanical fastener 46 onto a greater area of the mounting portion 82 to reduce the odds of tearing and to effect a more secure attachment. However, it is to be understood that the plate 88 need not be present in various exemplary embodiments of the mold 14. The mechanical fastener 46 creates a through hole through the mounting portion 82, but this through hole does not extend through the flexible portion inner surface 78 and does not compromise the ability of the bladder 16 to retain fluid 72. The puck 20 may be retained onto the mounting portion 82 and hence the flexible bladder 16 without the need to put any holes into the interior of the bladder 16.

The arrangements of the puck 20, mounting portion 82, and flexible portion 18 are only exemplary and others are possible. Although shown as using but a single mechanical fastener 46, any number of mechanical fasteners 46 can be employed. In other embodiments, from 2 to 6, from 2 to 8, 1, or up to 12 mechanical fasteners 46 may be used to effect attachment of the puck 20 to the mounting portion 82. The first and second pieces 42, 44 can engage one another in the disclosed arrangement, or they can be configured so that they are not in engagement with one another in yet other embodiments. Further, although two pieces 42, 44 are used to form the puck 20, the puck 20 can be formed of a single piece or any number of pieces in accordance with other exemplary embodiments. The puck 20 used to form the container 12 can be variously configured in accordance with other exemplary embodiments. Further, although shown with the use of a patch 30, in other embodiments the patch 30 is not present and instead the material to be placed inside of the cavity 22 comes from the inner surface 24. There should be sufficient material making up the inner surface 24 to allow some to flow into the cavity 22 when the puck 20 is urged against the inner surface 24 during the molding process.

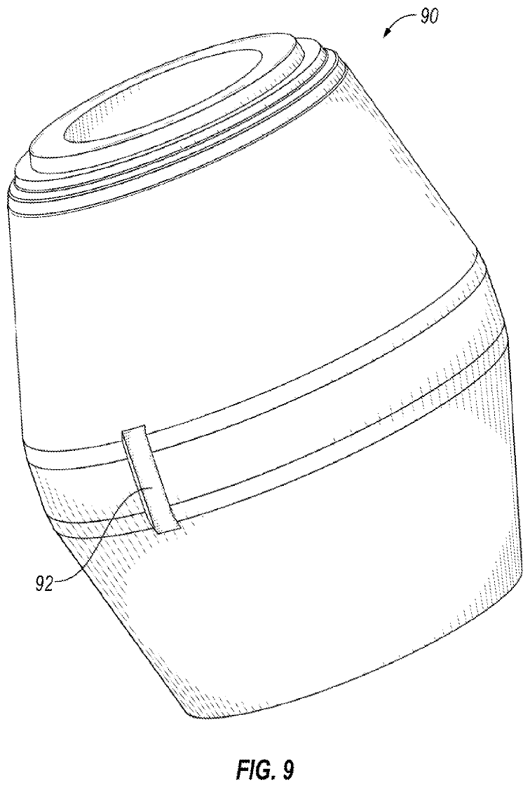

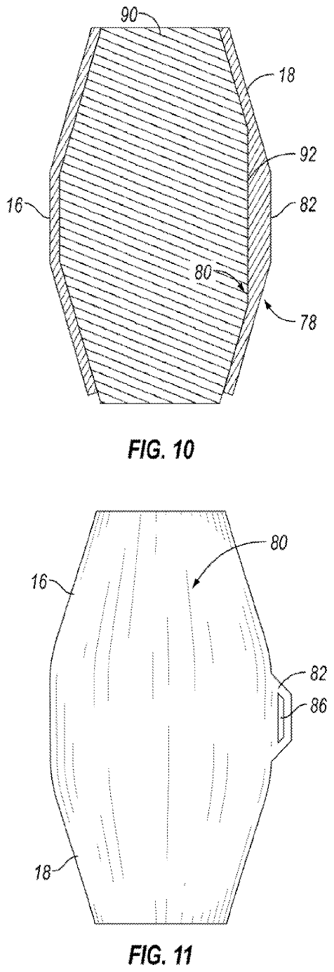

FIG. 9 shows an inner core mold 90 that can be used to form the bladder of FIG. 8. Uncured rubber can be placed onto the outer surface of the inner core mold 90 and this uncured rubber may in turn be subjected to heat and pressure to cure the rubber to a desired hardness so as to be capable of functioning as the bladder 16. In order to form the projection of the mounting portion 82 through which the through slit 86 is disposed, a depression 92 is cut into the inner core mold 90. Rubber may fill up this depression 92 so that extra rubber is in this location on the inner core mold 90. FIG. 10 is a cross-sectional view of the inner core mold 90 through this depression 92 which also shows the rubber applied to the inner core mold 90. As shown, a thicker region of rubber is formed at the depression 92 as opposed to areas of the flexible portion 18 remote from the depression 92. Once the rubber is cured to an acceptable hardness, the bladder 16 is removed from the inner core mold 90, and then turned inside out. FIG. 11 shows the bladder 16 after its removal and this inside out turning. The through slit 86 is cut into the projection at the mounting portion 82 to achieve the final design of the bladder 16. This bladder 16 can then be incorporated into the mold 14 for forming the tire 10 with the container 12.

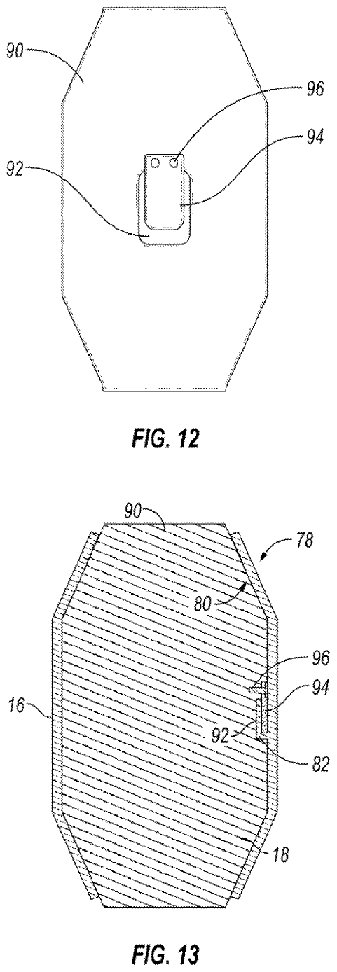

FIGS. 12 and 13 show an inner core mold 90 that is capable of making the bladder 16 as previously described in FIGS. 4-7 that has the tab shaped mounting portion 82. The inner core mold 90 has a depression 92 that is rectangular in shape. A rectangular shaped plate 94 is placed partially over this depression 92 and secured onto the inner core mold 90 with a pair of bolts 96. The rectangular shaped plate 94 covers some of the depression 92 but not all of the depression 92. Rubber can then be applied to this inner core mold 90 and subsequently cured to such an extent necessary to allow functioning as a bladder 16. FIG. 13 shows the rubber applied to the inner core mold 90 of FIG. 12. Rubber flows into the depression 92 and the presence of the plate 94 results in a separation of the rubber in the depression 92 from that forming the flexible portion 18 which can be seen in other figures as the space 84 between the tab of the mounting portion 82 and the flexible portion outer surface 80. Once formed, the bladder 16 is pulled off of the inner core mold 90 and then turned inside out to result in the bladder 16 as shown in FIGS. 4-7. It is to be understood that various inner core molds 90 can be constructed in order to build the bladders 16 in accordance with different embodiments, and that those shown and described with reference to FIGS. 9-13 are only exemplary.

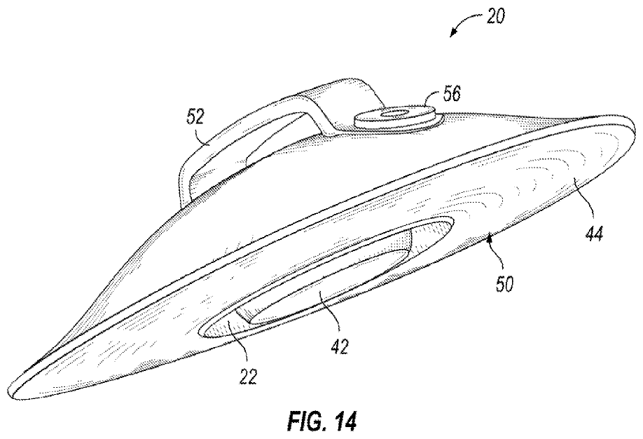

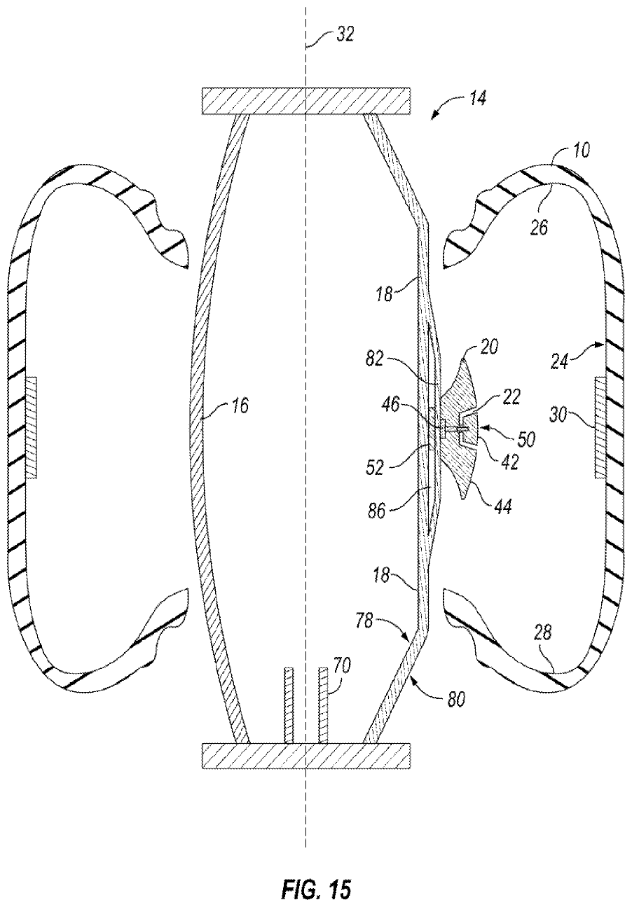

Another embodiment of the puck 20 is shown with reference to FIG. 14 in which the mechanical fastener 46 is not present. Instead, a buckle 52 is provided on an outer surface of the puck 20 and has an opening through which a mounting portion 82 can be disposed for holding the puck 20 onto the bladder 16. The buckle 52 is attached to the puck 20 through the use of two fasteners 56, only one of which is visible in FIG. 14 and it is to be understood that the one that is not visible in FIG. 14 is simply at the other side of the buckle 52 where it moves down into engagement with the second piece 44. FIG. 15 shows the puck 20 with the buckle 52 integrated into the bladder 16. The fasteners 56 may be engaged and disengaged in order to allow the mounting portion 82, which could be called a loop in this instance, to be disposed between the buckle 52 and the puck 20. The mounting portion 82 can completely fill this space so that it snugly holds the puck 20 to the flexible portion 18. A mechanical fastener 46 holds the first piece 42 and second piece 44 together to form the cavity 22 for engagement with the patch 30 and the inside of the tire 10 during the molding process. The mechanical fastener 46 does not extend through the mounting portion 82 but instead is located within a recess of the second piece 44. In other embodiments, the mechanical fastener 46 may additionally extend through the mounting portion 82. However, the disclosed embodiment in FIG. 15 does not have any apertures punched through the mounting portion 82, and the mounting portion 82 is a solid object.

The puck 20 has an engaging surface 50 that is convex in shape so that it is complimentary to the concave inner surface of the tire 10. The entire engaging surface 50 may have a convex shape, or only a portion of the engaging surface 50 may have a convex shape and the rest of it can be flat. In other embodiments, such as those shown with reference to FIGS. 4 and 8, the engaging surface 50 is flat and does not have a convex or concave shape. The engaging surface 50 is the portion of the puck 20 that engages the tire 10 during the molding process when the bladder 16 is inflated and urged against the inner surface of the tire 10. The engaging surface 50 is the surface of the puck 20 that is opposite to that of the buckle 52 or mechanical fastener 46 that engages the mounting portion 82. By having a convex shaped engaging surface 50, engagement with the concave inner surface of the tire 10 allows for a better angular orientation of the puck 20 against the patch 30 and inner surface to mold the container 12.

The described process and the mold 14 allow for the container 12 to be built into the tire 10 using a conventional tire building process in which a solid core is not needed. The pressure of the fluid 72 within the bladder 16 may be at 16 bar in some embodiments, and the tire 10 when going into the mold 14 can be a cold green tire 10. In other embodiments, from 10 to 20 bar of pressure may be applied within the bladder 16 during the curing process when the bladder 16 is forced against the tire 10. The container 12 is formed without having to place a mold onto the tire 10, but instead having the puck 20 placed onto the flexible portion 18 of the bladder 16. The surface that the container 12 is formed on is the inner surface 24 that is below the tread 74, and the container 12 is not formed on either one of the sidewalls 26 or 28.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

1. A mold for molding a tire that has a container, comprising:
a plurality of mold sectors;
a bladder that has a flexible portion that has a flexible portion inner surface and a flexible portion outer surface, wherein the mold sectors are distributed around the bladder;
a mounting portion carried by the flexible portion at a location of the flexible portion that lacks a through aperture from the flexible portion inner surface to the flexible portion outer surface; and
a puck attached to the mounting portion, wherein the puck has a cavity configured for molding the container onto an inner surface of the tire.

2. The mold as set forth in claim 1, wherein the mounting portion is integrally formed with the flexible portion.

3. The mold as set forth in claim 1, wherein the mounting portion is a tab that extends from the flexible portion outer surface, wherein a space is defined between the tab and the flexible portion outer surface.

4. The mold as set forth in claim 1, wherein the mounting portion is a projection that extends from the flexible portion outer surface and has a through slit.

5. The mold as set forth in claim 1, further comprising a mechanical fastener that attaches the puck to the mounting portion, wherein the mechanical fastener extends through the mounting portion.

6. The mold as set forth in claim 5, wherein the puck has a first piece and a second piece, wherein the cavity is defined between the first piece and the second piece, wherein the mechanical fastener is a bolt that connects the first piece to the second piece and extends through the mounting portion.

7. The mold as set forth in claim 5, further comprising a plate that engages the mounting portion and is located between the mounting portion and the flexible portion outer surface, wherein the mechanical fastener is a bolt and engages the plate and extends through the plate.

8. The mold as set forth in claim 1, wherein the tire is uncured and is located within the mold sectors, wherein the tire on an inner surface of the tire between two sidewalls of the tire has a patch of cushion gum that is the material that flows into the cavity of the puck to form the container, wherein the patch of cushion gum does not extend 360 degrees around an axis of the tire.

9. The mold as set forth in claim 1, wherein the flexible portion and the mounting portion are made of rubber, and wherein the puck is made of aluminum.

10. The mold as set forth in claim 1, wherein the cavity is configured for molding a lip into the container.

11. The mold as set forth in claim 1, wherein the bladder has an inflation port for adding a fluid into the bladder to expand the flexible portion, wherein the flexible portion has no through apertures from the flexible portion inner surface to the flexible portion outer surface.

12. The mold as set forth in claim 1, further comprising a buckle that attaches the puck to the mounting portion, wherein the mounting portion extends through a gap present between the buckle and the puck.

13. The mold as set forth in claim 1, wherein the puck has an engaging surface that is convex and that engages the inner surface of the tire.
